(19) United States
(12) Patent Application Publication
(10) Pub. No.: US 2014/0280758 A1
(43) Pub. Date: Sep. 18, 2014

(54) Methods and Systems for Providing Location-Based Subsidized Access to Network Content

(71) Applicant: VERIZON PATENT AND LICENSING INC., Arlington, VA (US)

(72) Inventors: Manish Sharma, San Jose, CA (US); Avinash S. Chugh, Nashua, NH (US); Michael Buonomo, Acton, MA (US)

(73) Assignee: VERIZON PATENT AND LICENSING INC., Arlington, VA (US)

(21) Appl. No.: 13/841,326

(22) Filed: Mar. 15, 2013

(51) Int. Cl. H04L 29/08

(52) U.S. Cl. CPC H04L 67/10
USPC 709/219

(57) ABSTRACT

An exemplary method includes a content delivery system 1) detecting a request provided by a mobile device associated with a user to access network content by way of a network provided by a network service provider, 2) determining that the mobile device is located within a sponsored geographic area at a time of the request, and 3) providing the user with subsidized access to the network content by way of the mobile device in accordance with a subsidized access arrangement between a sponsoring entity associated with the sponsored geographic area and the network service provider. Corresponding methods and systems are also disclosed.

### BACKGROUND INFORMATION

Network service providers (e.g., wireless carriers, Internet service providers, etc.) often charge users to access network content by way of the providers' networks based on the amount of data that the users utilize while accessing the network content. For example, a network service provider may impose a maximum data usage amount per billing period (i.e., a data usage quota) with excess data usage being billed separately, charge a predetermined amount per unit of data usage (e.g., when a wireless device user is roaming on another wireless network), or allow a user to pre-pay for a predetermined amount of data usage.

Unfortunately, while some entities (e.g., venue owners, advertisers, etc.) might be willing to pay for network access as a courtesy to users located at geographic areas with which the entities are associated (e.g., within the venue owned by a venue owner, at an event sponsored by an advertiser, etc.), none of the above-referenced billing arrangements allow such a sponsoring entity to be billed for the network content accessed by the users. In some circumstances, would-be sponsoring entities may provide this courtesy by providing their own networks (e.g., wireless local area networks (Wi-Fi networks)), but they are unable to leverage existing networks (e.g., cellular networks provided by cellular service providers) that the users may already be using. As a result, users may refrain from accessing network content that might be useful to the users in these geographic areas and would-be sponsoring entities may be forced to provide their own networks at great expense and hassle or forego offering this courtesy altogether.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary content delivery system according to principles described herein.

FIG. 2 illustrates an exemplary implementation of the system of FIG. 1 according to principles described herein.

FIG. 3 illustrates another exemplary implementation of the system of FIG. 1 according to principles described herein.

FIG. 4 illustrates how a mobile device may be outside a sponsored geographic area associated with a sponsoring entity according to principles described herein.

FIG. 5 illustrates an exemplary implementation of the system of FIG. 1 wherein a mobile device receives unsubsidized access to network content according to principles described herein.

FIG. 6 illustrates how a mobile device may enter a sponsored geographic area associated with a sponsoring entity according to principles described herein.

FIG. 7 illustrates an exemplary implementation of the system of FIG. 1 wherein a mobile device receives subsidized access to network content according to principles described herein.

FIGS. 8-10 illustrate notifications that may be presented to a user of a mobile device to indicate that a sponsoring entity is providing subsidized access to network content according to principles described herein.

FIG. 11 illustrates an exemplary implementation of the system of FIG. 1 wherein a mobile device receives subsidized access to some network content and unsubsidized access to other network content according to principles described herein.

FIG. 12 illustrates a notification that may be presented to a user of a mobile device to indicate that subsidized access to network content is terminated according to principles described herein.

FIG. 13 illustrates an exemplary method of providing subsidized access to network content according to principles described herein.

FIG. 14 illustrates another exemplary method of providing subsidized access to network content according to principles described herein.

FIG. 15 illustrates an exemplary computing device according to principles described herein.

### DETAILED DESCRIPTION OF PREFERRED EMBODIMENTS

Methods and systems for providing location-based subsidized access to network content are described herein. For example, as will be described below, a content delivery system may 1) detect a request provided by a mobile device associated with a user to access network content by way of a network provided by a network service provider, 2) determine that the mobile device is located within a sponsored geographic area at a time of the request, and 3) provide the user with subsidized access (e.g., free access) to the network content by way of the mobile device in accordance with a subsidized access arrangement between a sponsoring entity associated with the sponsored geographic area and the network service provider.

The methods and systems described herein may allow a sponsoring entity to subsidize access by a user to network content by way of a network associated with a particular network service provider when the user is located within a sponsored geographic area. Subsidized access to network content within a sponsored geographic area may cause users to form favorable impressions of the sponsoring entities providing the subsidized access courtesy. Likewise, subsidized access may encourage or incentivize users to access network content associated with (e.g., provided by) the sponsoring entities that the users may not otherwise choose to access due to the typical data usage charges associated therewith. This may allow users to experience and enjoy network content that they would not experience or enjoy otherwise, and may result in increased exposure, traffic, and/or revenue for the sponsoring entities.

As used herein, “network content” refers to any data, service, or content (e.g., Internet content) that may be accessed by way of a network. For example, network content may include, but is not limited to, a website, a network-based application (e.g., an application configured to be executed by a mobile device), a network-based service (e.g., an email service, a global positioning service (“GPS”) service, a navigation service, etc.), advertisement content (e.g., web-based advertisements, banner advertisements, pop-up advertisements, etc.), media content (e.g., video and/or audio content), and/or any other type of content accessible by way of a network as may serve a particular implementation.

As used herein, a “network service provider” may include any entity configured to provide one or more network access services (e.g., wireless data access services) to a user (e.g., a subscriber). For example, a network service provider may include, but is not limited to, a wireless carrier, a wireless network provider, an Internet service provider, a subscriber television service provider, and/or any other type of provider of network access services as may serve a particular implementation.

As used herein, a “sponsoring entity” may include any entity or person who arranges, pays for, or otherwise subsidizes access to network content by a user. A sponsoring entity may “subsidize” a data usage charge for access by a user to network content in any suitable manner. For example, the sponsoring entity may pay for all or part of the data usage charge in accordance with a subsidized access arrangement between the sponsoring entity and the network service provider. In this manner, the user may access the network content for free or at a reduced cost. A data usage charge for a user may additionally or alternatively be subsidized by reducing (e.g., eliminating) an amount of data that is counted against a user's data usage quota while the user accesses the network content, refunding all or part of the data usage charge to the user, and/or upgrading a quality of service (e.g., speed) for the data used to access the network content at a reduced cost to the user. Data subsidies may also be provided to the user by way of coupons, promotion codes, discounts, bundled pricing, etc. Other ways of subsidizing a data usage charge may also be used in accordance with the methods and systems described herein. For example, in some embodiments, the network service provider may subsidize the data usage charge in accordance with the methods and systems described herein.

As used herein, a “network content provider” or “content provider” may include any entity or person associated with network content other than a network service provider. For example, a content provider may include, but is not limited to, a website owner, an application developer, an application provider, an advertisement provider, a sponsoring entity who subsidizes access to users within a sponsored geographic area, an entity (i.e., a third party entity) other than the entity that actually provides and/or maintains the network content, etc.

FIG. 1 illustrates an exemplary content delivery system 100 (“system 100”). As shown, system 100 may include, without limitation, a detection facility 102, a subsidized access management facility 104, and a storage facility 106 selectively and communicatively coupled to one another. It will be recognized that although facilities 102-106 are shown to be separate facilities in FIG. 1, any of facilities 102-106 may be combined into fewer facilities, such as into a single facility, or divided into more facilities as may serve a particular implementation.

Detection facility 102 may be configured to detect a request provided by a mobile device associated with a user to access network content by way of a network provided by a network service provider (i.e., a “service provider network”). In some examples, the network content may be associated with (e.g., provided by) a network content provider and maintained by a network content provider subsystem.

Detection facility 102 may detect the request made by the mobile device to access the network content in any suitable manner. For example, detection facility 102 may detect that the user has entered a universal resource locator (“URL”) of the network content, selected a link (e.g., a hyperlink) associated with the network content, started a network-based application, session, or service (e.g., started an app on a mobile device), or otherwise directed the mobile device to request access to network content. In some examples, the request detected by detection facility 102 may include a multi-modal request (e.g., explicit requests for network content from applications such as web browsers, spoken audio commands, etc.).

Subsidized access management facility 104 may perform one or more subsidized access operations. For example, subsidized access management facility 104 may determine that the mobile device is located within a sponsored geographic area associated with a sponsoring entity at a time of the request. As used herein, a “sponsored geographic area” may include any geographic location or area as may be defined by a sponsoring entity in a subsidized access arrangement (e.g., a contract or other arrangement between the sponsoring entity and the network service provider detailing terms by which the subsidized access is provided). For example, a sponsored geographic area may include an outdoor area (e.g., a city park, an amusement park, a ski resort, etc.), the area within a structure (e.g., a retail store or mall, a sports stadium, a convention center, etc.), the area within a radius of a fixed location (e.g., an area within 200 feet of a building, an operating radius around a particular cellular tower, etc.), an area along a line or path (e.g., along the route of a parade, along a stretch of highway, etc.), or any combination of these or any other static or dynamic area that a sponsoring entity may define.

Further, the sponsoring entity may be associated with the sponsored geographic area in any way. In some examples, the sponsored geographic area may comprise an area in which the sponsoring entity has an ownership or other interest (e.g., a hotel owner may be a sponsoring entity associated with a sponsored geographic area that includes the hotel premises). Conversely, in other examples, the sponsoring entity may have no ownership or other interest in the sponsored geographic area (e.g., a soft drink company may be a sponsoring entity associated with a sponsored geographic area that includes a football stadium). For example, the sponsoring entity may have no association with the sponsored geographic area other than the association arising from the entity's capacity as a sponsoring entity for subsidized access to network content in the sponsored geographic area as it is detailed in the subsidized access arrangement.

The determination by the subsidized access management facility 104 that the mobile device is located within the sponsored geographic area associated with the sponsoring entity may be made in any suitable manner. For example, subsidized access management facility 104 may track the location of the mobile device by means of a Global Positioning System (“GPS”) capability built into the mobile device, by multilateration of radio signals, by measuring the distance of the mobile device from one or more objects with known locations (e.g., cellular towers, Wi-Fi networks, near field communication initiators (“NFC initiators”)) to triangulate the location of the mobile device, or by other suitable techniques to track and/or locate the mobile device as may serve a particular implementation.

In some examples, subsidized access management facility 104 may determine that the mobile device is located within the sponsored geographic area in response to the request provided by the mobile device to access the network content. For example, a user may first direct the mobile device to download or execute a network-based mobile application, to select a link, to access a website, or otherwise to provide a request to access network content. In response, subsidized access management facility 104 may determine that the mobile device is located within the sponsored geographic area and, accordingly, provide the user with subsidized access to the requested network content.

Additionally or alternatively, subsidized access management facility 104 may determine that the mobile device is located within the sponsored geographic area prior to the request being provided by the mobile device to access the network content. For example, subsidized access management facility 104 may determine that the mobile device is located within the sponsored geographic area and, in response, may provide a notification to the user that the user may take advantage of subsidized access to network content while located within the sponsored geographic area.

Subsidized access management facility 104 may be further configured to provide, based on the determination that the mobile device located within the sponsored geographic area at the time of the request, the user with subsidized access to the network content by way of the mobile device. This may be performed in any suitable manner. For example, subsidized access management facility 104 may provide the user with subsidized access to the network content in accordance with a subsidized access arrangement between the sponsoring entity associated with the sponsored geographic area and the network service provider. As mentioned, the subsidized access arrangement may include any suitable agreement, contract, and/or arrangement in which the sponsoring entity has agreed to subsidize access by one or more users to network content specified by the sponsoring entity. To illustrate, an exemplary subsidized access arrangement may specify that a retail mall owner has agreed to subsidize access by users to the website of the mall or any website of the mall's retailers while the users are located within the mall.

In some examples, the subsidized access arrangement may specify a manner in which user access to network content by way of a network associated with the network service provider is subsidized by the sponsoring entity. For example, the subsidized access arrangement may specify that a sponsoring entity may provide users with subsidized access to only specific network content (e.g., non-media-based network content, network content from one or more specific content providers, etc.). The subsidized access arrangement may identify the network content to be subsidized and may detail how subsidized access management facility 104 is to determine which particular network content is subsidized in any suitable manner. For example, the subsidized access arrangement may specify particular attributes of network content that subsidized access management facility 104 may detect in order to determine that user access to the content is subsidized. These attributes may include, but are not limited to, one or more network identifiers (e.g., a network address such as an internet protocol (“IF”) address and/or a URL of the network content), one or more metadata values associated with the network content, one or more indicators included in packet headers and/or source code associated with the network content, and/or any other information or characteristics of the network content as may serve a particular implementation.

The subsidized access arrangement may additionally or alternatively specify one or more other attributes associated with the subsidized user access. For example, the subsidized access arrangement may define boundaries of the sponsored geographic area, a percentage of data usage charges that the sponsoring entity will pay for (e.g., 50%), a set dollar amount that the sponsoring entity will subsidize per mobile device (e.g., up to $3.00), an amount of data that the sponsoring entity will subsidize for a user (e.g., up to 100 MB, a download of a particular mobile application or media file, etc.), specific time periods during which the sponsoring entity will subsidize access (e.g., times of day, days of week, holidays, etc.), time limits for how long the sponsoring entity will subsidize access (e.g., two hours, until midnight, until a store closes, until an event concludes, etc.), a manner in which the sponsoring entity will reimburse the network service provider for the access it will subsidize (e.g., by a prepaid account with the network service provider, by electronic billing, by automatic withdrawal from a bank account, etc.), specific user profile characteristics that the user has to meet in order to receive subsidized access to the network content (e.g., users who have subscribed to a network service, users who have “liked” the sponsoring entity on Facebook, etc.), specific types of content that the sponsoring entity will subsidize (e.g., audio-based content, video-based content, Internet-based content, etc.), promotion codes or coupons that the user may enter in order to receive subsidized access to the network content, additional network content to which the content provider will subsidize user access in exchange for performing a predefined action, and/or any other condition as may serve a particular implementation.

Subsidized access management facility 104 may provide the user with subsidized access to the network content in accordance with a subsidized access arrangement in any suitable manner. For example, subsidized access management facility 104 may provide the user with subsidized access (e.g., free access) to the network content by tracking an amount of data transmitted between the mobile device and the network while the mobile device is located within the sponsored geographic area and while the user accesses the network content (e.g., by counting the number of bytes of data transmitted between the mobile device and a network content provider subsystem while the user accesses the network content) and by directing the network service provider to adjust a data usage charge to the user for the tracked data in accordance with the subsidized access arrangement. Subsidized access management facility 104 may direct the network service provider to adjust the data usage charge in any suitable manner. For example, subsidized access management facility 104 may direct the network service provider to bill the sponsoring entity for at least a portion of the data usage charge. The tracking and directing may be performed by subsidized access management facility 104 utilizing the mobile device (e.g., code residing on the mobile device), a reverse billing subsystem, and/or in any other manner as may serve a particular implementation.

Subsidized access management facility 104 may be further configured to direct the mobile device to present a notification that access by the user to the network content is subsidized by the sponsoring entity. This may be performed in any suitable manner. For example, subsidized access management facility 104 may direct the mobile device to display the notification in a pop-up alert, as a banner notification, within a webpage, within a user interface of an application, or in any other suitable manner. Exemplary notifications will be described in more detail below.

In some examples, subsidized access management facility 104 may direct the mobile device to present the notification in response to the request being provided by the mobile device to access the network content. Additionally or alternatively, subsidized access management facility 104 may determine that the mobile device is located within the sponsored geographic area at a time prior to the detecting of the request. Subsidized access management facility 104 may then direct the mobile device to present the notification that access by the user to the network content is subsidized by the sponsoring entity prior to the request being provided by the mobile device to access the network content.

In some examples, subsidized access management facility 104 may be configured to further condition the subsidized access on a performance by the user of a predefined action specified in the subsidized access arrangement. In this manner, the sponsoring entity may incentivize a user to perform a predefined action while located within the sponsored geographic area.

For example, a restaurant may wish to incentivize users to access the restaurant's website while the users are located within the restaurant. To this end, the restaurant may subsidize access to additional network content (e.g., full access to the Internet) in response to the users' accessing the website of the restaurant. In this way, sponsoring entities may incentivize users to perform any predefined action. Other actions that may be performed by a user in order to receive subsidized access to network content while located within a sponsored geographic area include, but are not limited to, performing a social networking action (e.g., “liking” the sponsoring entity on Facebook, “pinning” content associated with the sponsoring entity on Pinterest, etc.), downloading a mobile application, providing a user review, responding to a survey, and/or any other action as may serve a particular implementation.

Subsidized access management facility 104 may be further configured to provide a user with subsidized access to network content in accordance with a user profile associated with the user. In this way, a sponsoring entity may differentiate between users so as to provide different levels of subsidized access to network content while the users are located within the sponsored geographic area. For example, a coffee shop may provide subsidized access to all network content for users who are determined to be registered members of a loyalty club of the coffee shop while the users are located within the coffee shop. However, the coffee shop may provide only limited subsidized access to users who are not registered members of the loyalty club while these users are located within the coffee shop.

Subsidized access management facility 104 may be configured to authenticate the user, the mobile device, and/or the location of the mobile device in order to ensure that the user and/or mobile device is authorized to receive subsidized access to the network content. For example, subsidized access management facility 104 may verify one or more identities, credentials, and/or permissions of the user, the mobile device, and/or the location of the mobile device (e.g., in order to prevent fraud).

In some examples, a user receiving subsidized access to network content may move outside the sponsored geographic area. This may be detected in any suitable manner. For example, subsidized access management facility 104 may determine that the mobile device is located outside of the sponsored geographic area. In response, subsidized access management facility 104 may terminate the subsidized access to the network content in accordance with the subsidized access arrangement. An example of this will be provided in more detail below.

In some examples, subsidized access management facility 104 may detect an occurrence of a subsidized access termination event (or “termination event”) while the user is being provided with the subsidized access to the network content and while the mobile device continues to be located within the sponsored geographic area. Exemplary termination events include, but are not limited to, an expiration of a predefined time limit, a conclusion of an event taking place at a venue associated with the sponsored geographic area, etc. In response to the occurrence of the termination event, subsidized access management facility 104 may terminate the subsidized access to the network content. Examples of this will be provided in more detail below.

Once subsidized access management facility 104 has terminated the subsidized access to the network content, subsidized access management facility 104 may provide the user with unsubsidized access to the network content that continues from the subsidized access without substantial interruption. For example, a user's access to network content by way of a mobile device may continue uninterrupted when the user leaves the sponsored geographic area or when a subsidized access termination event occurs, but the access may no longer be subsidized by the sponsoring entity. In some examples, subsidized access management facility 104 may notify the user of this transition from subsidized to unsubsidized access.

Storage facility 106 may be configured to maintain subsidized access data 108 generated and/or used by detection facility 102 and/or subsidized access management facility 104. For example, subsidized access data 108 may include, but is not limited to, data representative of provisions and rules set out in a subsidized access arrangement (e.g., boundaries of sponsored geographic areas, time and content restrictions for subsidized access, etc.), tracked data usage, user profile and authentication data, and/or any additional or alternative data as may serve a particular implementation.

FIG. 2 illustrates an exemplary implementation 200 of system 100. As shown, implementation 200 includes a mobile device 202 associated with (e.g., used by) a user 204, a network service provider subsystem 206 (“service provider subsystem 206”) associated with (e.g., maintained by) a network service provider 208, and a network content provider subsystem 210 (“content provider subsystem 210”). Each of these elements will now be described in detail.

Mobile device 202 may be configured to facilitate access by user 204 to network content provided by content provider subsystem 210 by way of service provider subsystem 206. To this end, as will be described below, mobile device 202 may communicate with content provider subsystem 210 by way of service provider network 212 and content network 214. Mobile device 202 may be implemented by any suitable mobile device, such as a wireless device (e.g., a cellular phone, a smart phone, a tablet computer, etc.), a personal computer (e.g., a notebook or netbook computer), a digital music player, an e-book reader, a personal-digital assistant device, a gaming device, and/or any other suitable mobile computing device configured to access network content.

Service provider subsystem 206 may be associated with (e.g., owned and/or operated by) network service provider 208 and may be configured to provide one or more network access services (e.g., wireless data access services) to mobile device 202. For example, service provider subsystem 206 may be configured to manage (e.g., track, allow, disallow, route, etc.) network traffic (i.e., data representing network content) that flows through service provider network 212. To this end, service provider subsystem 206 may be implemented by one or more gateways, routers, servers (e.g., DNS servers and/or billing management servers), and/or other network components as may serve a particular implementation.

Content provider subsystem 210 may be associated with one or more suitable network content providers and may be configured to provide network content that may be accessed by mobile device 202. For example, content provider subsystem 210 may be implemented by a combination of computing devices (e.g., servers) associated with one or more content providers as may serve a particular implementation.

Mobile device 202, service provider subsystem 206, and content provider subsystem 210 may communicate with one another using any suitable communication technologies, devices, media, and protocols supportive of data communications, including, but not limited to, socket connections, Ethernet, data bus technologies, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Evolution Data Optimized Protocol (“EVDO”), 4G Long Term Evolution (“LTE”), WiMax, Time Division Multiple Access (“TDMA”) technologies, Short Message Service (“SMS”), Multimedia Message Service (“MMS”), radio frequency (“RF”) signaling technologies, wireless communication technologies (e.g., Bluetooth, Wi-Fi, etc.), in-band and out-of-band signaling technologies, and other suitable communications technologies.

As shown, mobile device 202, service provider subsystem 206, and content provider subsystem 210 may communicate by way of service provider network 212 and content network 214. Service provider network 212 may include any provider-specific network (e.g., a wireless carrier network or a mobile telephone network). Content network 214 may include a content provider-specific network, the Internet, or any other suitable network. Data may flow between service provider network 212 and content network 214 using any suitable communication technologies, devices, media, and protocols as may serve a particular implementation.

While two interconnected networks 212 and 214 are shown in FIG. 2, it will be recognized that networks 212 and 214 may be combined into a single network in accordance with the methods and systems described herein. Likewise, it will be recognized that mobile device 202 may access network content by way of more than two interconnected networks in accordance with the methods and systems described herein as may serve a particular implementation.

FIG. 2 also shows that a sponsoring entity 216 may be associated with network service provider 208 by way of a subsidized access arrangement 218. Subsidized access arrangement 218 may include any of the subsidized access arrangements described herein.

FIG. 3 illustrates another exemplary implementation 300 of system 100. Implementation 300 is similar to implementation 200 shown in FIG. 2, except that implementation 300 also includes a sponsoring entity subsystem 302 associated with (e.g., managed by) sponsoring entity 216. As shown, sponsoring entity subsystem 302 may be communicatively coupled to content network 214. However, it will be recognized that sponsoring entity subsystem 302 may be additionally or alternatively communicatively coupled to service provider network 212.

Sponsoring entity subsystem 302 may be configured to communicate with service provider subsystem 206 via content network 214 to enable and/or facilitate operations between sponsoring entity 216 and network service provider 208. For example, sponsoring entity subsystem 302 may allow sponsoring entity 216 to setup, configure, and/or modify subsidized access arrangement 218 with network service provider 208. Additionally or alternatively, sponsoring entity subsystem 302 may facilitate billing by network service provider 208, payment by sponsoring entity 216, and/or any other operations performed by network service provider 208 and/or sponsoring entity 216 which require information transfer between the two. Additionally or alternatively, sponsoring entity subsystem 302 may facilitate communication between sponsoring entity 216 and content provider subsystem 210. Sponsoring entity subsystem 302 may be implemented by any suitable combination of one or more computing devices. For example, sponsoring entity subsystem 302 may be implemented by one or more servers (e.g., proxy servers).

System 100 may be implemented entirely by or within mobile device 202, service provider subsystem 206, content provider subsystem 210, and/or sponsoring entity subsystem 302. For example, system 100 may be implemented entirely by mobile device 202 or by service provider subsystem 206. In other embodiments, components of system 100 may be distributed across any combination or sub-combination of mobile device 202, service provider subsystem 206, content provider subsystem 210, and sponsoring entity subsystem 302.

Various examples of the methods and systems described herein will now be provided. It will be recognized that the examples provided herein are merely illustrative of the many different examples that may be realized in accordance with the methods and systems described herein.

FIG. 4 shows a scenario 400 in which a mobile device 202 associated with a user 204 is physically located at a particular geographic location within an exemplary network footprint 402 of service provider network 212. Network footprint 402 refers to a collective geographic space within which mobile device 202 is able to receive and transmit network communication signals (e.g., signals to or from a satellite or a broadcast tower) with service provider network 212. As represented by arrows in FIG. 4, the reach of the network footprint 402 may extend beyond the illustrated portion of the network footprint 402. Additionally, while FIG. 4 illustrates a two-dimensional network footprint 402, it will be understood that network footprint 402 may be three dimensional in certain implementations.

FIG. 4 also illustrates an exemplary sponsored geographic area 404 that may be associated with a sponsoring entity. As previously described herein, the association between a sponsoring entity and a sponsored geographic area may include any suitable association. For instance, in some examples the sponsoring entity may have a physical presence within sponsored geographic area 404. For example, a restaurant chain may provide subsidized access to network content within geographic areas at which its restaurants are located. Conversely, in other examples the sponsoring entity may have no physical presence with sponsored geographic area 404. For example, the restaurant chain of the example above may provide subsidized access to network content within a city park (e.g., for advertising purposes). The restaurant chain may not have any restaurant or other physical presence in the vicinity of the park, but may subsidize access to network content within the park for advertising or other purposes on a permanent basis or on a temporary basis (e.g., during a firework show, concert, or other event taking place at the park).

As shown in FIG. 4, mobile device 202 and user 204 are initially located outside the boundaries of sponsored geographic area 404. Accordingly, access by user 204 to network content with mobile device 202 may not be subsidized by the sponsoring entity.

To illustrate, FIG. 5 shows an exemplary implementation 500 of system 100 wherein user 204 of mobile device 202 receives unsubsidized access to network content. Because user 204 and mobile device 202 are located outside of sponsored geographic area 404 in this example, sponsoring entity 216 does not subsidize access to network content for user 204. At this location, user 204 may still access network content from content provider subsystem 210 (e.g., by way of mobile device 202, service provider network 212, service provider 208, and content network 214), but the access is unsubsidized (e.g., user 204 will be responsible to pay applicable data usage charges to network service provider 208). This unsubsidized access is illustrated by dataflow 502. Because dataflow 502 is unsubsidized, it is illustrated as a dashed line. As shown by dataflow 502, data flowing in either direction passes through service provider subsystem 206, where an amount of data transmitted may be tracked for billing and/or other purposes.

In contrast, FIG. 6 illustrates a scenario 600 in which user 204 and mobile device 202 continue to be located within network footprint 402 but where they have moved to a location within sponsored geographic area 404. In this scenario 600, access by user 204 to network content with mobile device 202 may be subsidized by the sponsoring entity.

To illustrate, FIG. 7 shows an exemplary implementation 700 of system 100 wherein user 204 of mobile device 202 receives subsidized access to network content. As with implementation 500, the network content flows between user 204 and content provider subsystem 210 (e.g., by way of mobile device 202, service provider network 212, service provider 208, and content network 214) in accordance with subsidized access arrangement 218. This subsidized access is illustrated by dataflow 702. Because dataflow 702 is subsidized, it is illustrated as a solid line.

In conjunction with providing the subsidized access to the network content as illustrated in FIG. 7, system 100 may provide various types of notifications via mobile device 202 to inform user 204 about various aspects of the subsidized access.

For example, FIG. 8 illustrates an exemplary subsidized access notification 802 that may be presented by way of (e.g., displayed by) mobile device 202 to indicate that subsidized access is available to user 204 of mobile device 202. Notification 802 may be provided in response to a request provided by mobile device 202 to access network content by way of a network and in response to a determination that the mobile device is located within a sponsored geographic area the time of the request. For example, a sponsoring entity may subsidize access by users to network content while the users are located within a football stadium. Accordingly, if user 204 carries mobile device 202 into the football stadium and uses mobile device 202 to access network content while in the football stadium, system 100 may direct mobile device 202 to display notification 802. In some examples, as shown, notification 802 may be presented on top of other graphics 804 presented by mobile device 202 (e.g., in the form of a pop-up window). Notification 802 may alternatively be presented in any other manner.

As shown, notification 802 may include various selectable options. For example, notification 802 may include an “accept” option 806 and a “cancel” option 808. The “accept” option 806 may be selected by user 204 to accept the subsidized access from the sponsoring entity and commence accessing the network content with subsidization from the sponsoring entity. The “cancel” option 808 may be selected by user 204 to reject the subsidized access from the sponsoring entity and continue accessing the network content without subsidization.

In other examples, notification 802 may be provided in response to a determination that the mobile device is located within the sponsored geographic area at a time prior to the request by mobile device 202 to access the network content. For example, as user 204 carries mobile device 202 into the football stadium of the example above, mobile device 202 may be directed to display notification 802 prior to any attempt by user 204 to access network content using mobile device 202. Additionally, an audible, vibrational, or other type of alert may accompany notification 802 to direct the attention of user 204 to notification 802.

FIG. 9 shows another exemplary notification 902 that may be presented by way of mobile device 202 and that may be configured to notify user 204 that access to network content is being subsidized by a sponsoring entity. As shown, notification 902 may be presented in the form of a banner notification, which may be configured to drop down from the top of the screen to overlay other graphics 804 of mobile device 202. As shown, notification 902 may specify information, conditions, and/or limitations associated with the subsidized access. For example, notification 902 includes a sponsor indicator 904 indicating that “I&J Burgers” is the “sponsor” (i.e., the sponsoring entity), a content scope indicator 906 indicating that “All” network content available on the network is being subsidized, a time limit indicator 908 indicating that subsidized access of the network content will be provided for 30 minutes, and a data limit indicator 910 indicating that up to 100 MB of network content will be subsidized in this session.

As previously described herein, in some examples, a sponsoring entity may wish to induce a predefined action by a user and, accordingly, may provide subsidized access to network content as an incentive for the user to perform the predefined action. For example, a sponsoring entity may provide a user with a free download of a song or other media content instance in exchange for accessing (e.g., viewing) an advertisement provided by the sponsoring entity while the mobile device is located within the sponsored geographic area.

To illustrate, a shopping mall operator may provide subsidized access for users within the mall to websites associated with the mall or retailers within the mall. However, the mall operator may choose to further subsidize all network content (e.g., other websites not associated with the mall or its retailers) for users who perform a predefined action (e.g., for users who download a mobile application associated with the mall). This type of incentive may be defined in a subsidized access arrangement between the mall operator and a network service provider.

Potential users may be notified of the incentive in any suitable manner. For example, FIG. 10 illustrates an exemplary notification 1002 that may be provided for display on mobile device 202 and that may be configured to notify user 204 of an offer for free access to network content if the user 204 downloads a mobile application associated with the shopping mall. As shown, notification 1002 may include a selectable option 1004 configured to facilitate downloading of the mobile application. Notification 1002 may further include a “cancel” option configured to allow user 204 to decline the offer.

It will be recognized that although the exemplary notifications described herein have all included text, it will be recognized that the notifications may additionally or alternatively include any graphical content (e.g., one or more images), audio content (e.g., one or more audible sounds), and/or any other type of content that may be used to notify a user (e.g., during a current context of the user's network content access session) that access to network content is or is not subsidized. For example, a notification may include an audio prompt within a streaming audio session. Additionally or alternatively, the notification may include a video insert or text overlay into a video stream in the context of a streaming video session.

As mentioned above, subsidized access to network content may also be content-based. For example, system 100 may provide a user located within a sponsored geographic area with subsidized access to some types of network content (e.g., network content associated with the sponsoring entity) as specified in the subsidized access arrangement and unsubsidized access to other types of network content (e.g., high-bandwidth network content such as video) as specified in the subsidized access arrangement. Additionally or alternatively, system 100 may provide subsidized access only to network content from particular sources of network content.

To illustrate, FIG. 11 shows an exemplary implementation 1100 of system 100 in which subsidized access to network content is both location-based and content-based. Implementation 1100 is similar to implementation 700, except that in implementation 1100, content provider subsystem 210 is implemented by network content servers 1102-1 through 1102-3 (collectively “network content servers 1102”). Each network content server 1102 is configured to provide different network content. In the example of FIG. 11, mobile device 202 and user 204 are located within a sponsored geographic area.

As illustrated by dataflows 1104-1 and 1104-2 (i.e., the dashed lines), system 100 may provide user 204 with unsubsidized access to network content provided by network content servers 1102-1 and 1102-2. However, as illustrated by dataflow 1104-3 (i.e., the solid line), system 100 may provide user 204 with subsidized access to network content provided by network content server 1102-3. System 100 may differentiate between network content servers 1102 in any suitable manner.

As previously described herein, a user may leave a sponsored geographic area with his or her mobile device while system 100 is providing the user with subsidized access to network content. Accordingly, system 100 may determine that the mobile device is located outside of the sponsored geographic area and, in response, may terminate the subsidized access to the network content. Alternatively, system 100 may detect an occurrence of a subsidized access termination event while the user and his or her mobile device are located within the sponsored geographic area and are receiving the subsidized access to network content. In response to detecting the occurrence of the subsidized access termination event, subsidized access management facility 104 may similarly terminate the subsidized access to the network content, even though the mobile device may remain in the sponsored geographic area.

Subsidized access termination events may be specified in a subsidized access arrangement and may include any suitable events or limitations that a sponsoring entity deems suitable for terminating the subsidized access of one or more users. For example, a subsidized access termination event may include an expiration of a predefined time limit for the providing of the subsidized access. The predefined time limit may dictate that the subsidized access is terminated for all users at a particular time (e.g., the time a business closes for the day), or it may be specific to each mobile device (e.g., one hour of subsidized access may be provided per mobile device per day).

In other examples, the subsidized access termination event may include a conclusion of an event taking place at a venue associated with the sponsored geographic area. For example, system 100 may be configured to terminate subsidized access at the conclusion of a baseball game where the sponsored geographic area is the ballpark or at the conclusion of a fireworks display where the sponsored geographic area is the area surrounding a park where the fireworks display is visible.

In other examples, system 100 may detect an occurrence of a subsidized access termination event by detecting that an amount of data transmitted between the mobile device and the network while accessing the network content exceeds a predetermined maximum threshold amount. For example, the subsidized access arrangement may specify that a particular mobile device may be subsidized for up to 100 MB of data. On reaching that limit, system 100 may be configured to terminate the subsidized access to the mobile device.

In yet other examples, system 100 may detect an occurrence of a subsidized access termination event by detecting a predefined action performed by the user. For example, subsidized access provided to a hotel patron while the hotel patron is checked into the hotel may be configured to terminate when the hotel patron checks out of the hotel.

FIG. 12 illustrates an exemplary notification 1202 that may be presented to a user by way of mobile device 202 in response to a termination of the user's subsidized access to network content. As shown, notification 1202 may include a message 1204 notifying the user of the termination of the subsidized access (e.g., “Goodbye and thank you for dining with us!”). As with other notifications described herein, all elements of notification 1202 are exemplary. Any suitable elements and functionality may be added to or removed from notification 1202 as may suit a particular implementation.

FIG. 13 illustrates an exemplary method 1300 of providing location-based subsidized access to network content. While FIG. 13 illustrates exemplary steps according to one embodiment, other embodiments may omit, add to, reorder, and/or modify any of the steps shown in FIG. 13. One or more of the steps shown in FIG. 13 may be performed by system 100 and/or any implementation thereof.

In step 1302, a content delivery system detects a request provided by a mobile device associated with a user to access network content by way of a network provided by a network service provider. Step 1302 may be performed in any of the ways described herein.

In step 1304, the content delivery system determines that the mobile device is located within a sponsored geographic area at a time of the request. Step 1304 may be performed in any of the ways described herein.

In step 1306, the content delivery system provides the user with subsidized access to the network content by way of the mobile device in accordance with a subsidized access arrangement between a sponsoring entity associated with the sponsored geographic area and the network service provider. Step 1306 may be performed in any of the ways described herein.

FIG. 14 illustrates another exemplary method 1400 of providing location-based subsidized access to network content. While FIG. 14 illustrates exemplary steps according to one embodiment, other embodiments may omit, add to, reorder, and/or modify any of the steps shown in FIG. 14. One or more of the steps shown in FIG. 14 may be performed by a mobile device.

In step 1402, a mobile device receives a request provided by a user to access network content by way of a network provided by a network service provider. Step 1402 may be performed in any of the ways described herein.

In step 1404, the mobile device detects a geographic location of the mobile device at a time of the request. Step 1404 may be performed in any of the ways described herein.

In step 1406, the mobile device determines that the geographic location is within a sponsored geographic area. Step 1406 may be performed in any of the ways described herein.

In step 1408, the mobile device provides the user with subsidized access to the network content by way of the mobile device in accordance with a subsidized access arrangement between a sponsoring entity associated with the sponsored geographic area and the network service provider. Step 1408 may be performed in any of the ways described herein.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

FIG. 15 illustrates an exemplary computing device 1500 that may be configured to perform one or more of the processes described herein. As shown in FIG. 15, computing device 1500 may include a communication interface 1502, a processor 1504, a storage device 1506, and an input/output (“I/O”) module 1508 communicatively connected via a communication infrastructure 1510. While an exemplary computing device 1500 is shown in FIG. 15, the components illustrated in FIG. 15 are not intended to be limiting. Additional or alternative components may be used in other embodiments. Components of computing device 1500 shown in FIG. 15 will now be described in additional detail.

Communication interface 1502 may be configured to communicate with one or more computing devices. Examples of communication interface 1502 include, without limitation, a wired network interface (such as a network interface card), a wireless network interface (such as a wireless network interface card), a modem, an audio/video connection, and any other suitable interface.

Processor 1504 generally represents any type or form of processing unit capable of processing data or interpreting, executing, and/or directing execution of one or more of the instructions, processes, and/or operations described herein. Processor 1504 may direct execution of operations in accordance with one or more applications 1512 or other computer-executable instructions such as may be stored in storage device 1506 or another computer-readable medium.

Storage device 1506 may include one or more data storage media, devices, or configurations and may employ any type, form, and combination of data storage media and/or device. For example, storage device 1506 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1506. For example, data representative of one or more executable applications 1512 configured to direct processor 1504 to perform any of the operations described herein may be stored within storage device 1506. In some examples, data may be arranged in one or more databases residing within storage device 1506.

I/O module 1508 may be configured to receive user input and provide user output and may include any hardware, firmware, software, or combination thereof supportive of input and output capabilities. For example, I/O module 1508 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1508 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1508 is configured to provide graphical data to a display for presentation to a user. The graphical data may be representative of one or more graphical user interfaces and/or any other graphical content as may serve a particular implementation.

In some examples, any of the systems, subsystems, and/or facilities described herein may be implemented by or within one or more components of computing device 1500. For example, one or more applications 1512 residing within storage device 1506 may be configured to direct processor 1504 to perform one or more processes or functions associated with detection facility 102 and/or subsidized access management facility 104. Likewise, storage facility 106 may be implemented by or within storage device 1506.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
detecting, by a content delivery system, a request provided by a mobile device associated with a user to access network content by way of a network provided by a network service provider;
determining, by the content delivery system, that the mobile device is located within a sponsored geographic area at a time of the request; and
providing, by the content delivery system based on the determining that the mobile device is located within the sponsored geographic area at the time of the request, the user with subsidized access to the network content by way of the mobile device in accordance with a subsidized access arrangement between a sponsoring entity associated with the sponsored geographic area and the network service provider.

2. The method of claim 1, wherein the providing the user with the subsidized access to the network content comprises:
tracking an amount of data transmitted between the mobile device and the network while the mobile device is located within the sponsored geographic area and while the user accesses the network content; and
directing the network service provider to adjust a data usage charge to the user for the tracked data in accordance with the subsidized access arrangement.

3. The method of claim 2, wherein the directing of the network service provider to adjust the data usage charge comprises directing the network service provider to bill the sponsoring entity for at least a portion of the data usage charge.

4. The method of claim 1, wherein the providing the user with the subsidized access to the network content comprises providing the user with free access to the network content in accordance with the subsidized access arrangement.

5. The method of claim 1, further comprising:
determining, by the content delivery system while providing the user with the subsidized access to the network content, that the mobile device is located outside of the sponsored geographic area; and
terminating, by the content delivery system in response to the determining that the mobile device is located outside of the sponsored geographic area and in accordance with the subsidized access arrangement, the subsidized access to the network content.

6. The method of claim 1, further comprising:
detecting, by the content delivery system while providing the user with the subsidized access to the network content and while the mobile device is located within the sponsored geographic area, an occurrence of a subsidized access termination event; and
terminating, by the content delivery system in response to the detecting of the occurrence of the subsidized access termination event, the subsidized access to the network content.

7. The method of claim 6, wherein the subsidized access termination event comprises an expiration of a predefined time limit for the providing of the subsidized access.

8. The method of claim 6, wherein the subsidized access termination event comprises a conclusion of an event taking place at a venue associated with the sponsored geographic area.

9. The method of claim 6, wherein the detecting of the occurrence of the subsidized access termination event comprises detecting that an amount of data transmitted between the mobile device and the network while accessing the network content exceeds a predetermined maximum threshold amount.

10. The method of claim 6, wherein the detecting of the occurrence of the subsidized access termination event comprises detecting a predefined action performed by the user.

11. The method of claim 1 further comprising:
terminating, by the content delivery system in accordance with the subsidized access arrangement, the subsidized access to the network content; and
providing, by the content delivery system in response to the terminating, the user with unsubsidized access to the network content by way of the mobile device, wherein the unsubsidized access continues from the subsidized access without substantial interruption.

12. The method of claim 1, further comprising:
determining, by the content delivery system, that the network content has one or more attributes specified in the subsidized access arrangement,
wherein the providing of the subsidized access to the network content is further based on the determination that the network content has the one or more attributes.

13. The method of claim 1, wherein the determining that the network content has the one or more attributes comprises determining that the network content is associated with the sponsoring entity.

14. The method of claim 1, further comprising:
detecting, by the content delivery system, a performance by the user of a predefined action as specified in the subsidized access arrangement;
wherein the providing the user with the subsidized access to the network content is further performed in response to the performance of the predefined action.

15. The method of claim 1, further comprising directing, by the content delivery system in response to the determining that the mobile device is located within the sponsored geographic area at the time of the request, the mobile device to present a notification that access by the user to the network content is subsidized by the sponsoring entity.

16. The method of claim 1, further comprising:
determining, by the content delivery system, that the mobile device is located within the sponsored geographic area at a time prior to the detecting of the request; and
directing, by the content delivery system in response to the determining that the mobile device is located within the sponsored geographic area at the time prior to the detecting of the request, the mobile device to present a notification that access by the user to the network content is subsidized by the sponsoring entity.

17. The method of claim 1, wherein the providing the user with the subsidized access to the network content is further performed in accordance with a user profile associated with the user.

18. The method of claim 1, embodied as computer-executable instructions on at least one non-transitory computer-readable medium.

19. A method comprising:
receiving, by a mobile device, a request provided by a user to access network content by way of a network provided by a network service provider;
detecting, by the mobile device in response to the request, a geographic location of the mobile device at a time of the request;
determining, by the mobile device, that the geographic location is within a sponsored geographic area; and
providing, by the mobile device in response to the determining that the geographic location is within the sponsored geographic area, the user with subsidized access to the network content by way of the mobile device in accordance with a subsidized access arrangement between a sponsoring entity associated with the sponsored geographic area and the network service provider.

20. The method of claim 19, embodied as computer-executable instructions on at least one non-transitory computer-readable medium.

21. A system comprising:
a detection facility configured to detect a request provided by a mobile device associated with a user to access network content by way of a network provided by a network service provider; and
a subsidized access management facility communicatively coupled to the detection facility and configured to
determine that the mobile device is located within a sponsored geographic area at a time of the request, and
provide the user with subsidized access to the network content by way of the mobile device in accordance with a subsidized access arrangement between a sponsoring entity associated with the sponsored geographic area and the network service provider.
